(19) United States
(12) Patent Application Publication
(10) Pub. No.: US 2021/0070441 A1
(43) Pub. Date: Mar. 11, 2021

(54) Autonomous Virtual Wall

(71) Applicant: VALQARI HOLDINGS, LLC, Batavia, IL (US)

(72) Inventors: Ryan Walsh, Aurora, IL (US); Alex J. Falesch, Oswego, IL (US)

(21) Appl. No.: 17/082,651

(22) Filed: Oct. 28, 2020

Related U.S. Application Data
(63) Continuation of application No. PCT/US2019/031513, filed on May 9, 2019.
(60) Provisional application No. 62/668,846, filed on May 9, 2018.

(51) Int. Cl. B64C 39/02

(52) U.S. Cl. CPC B64C 39/024; B64C 2201/128; B64C 2201/146; B64C 2201/141; B64C 2201/027; B64C 2201/127

(57) ABSTRACT

A virtual security network system can be used to prevent, deter or cease intrusion of an unauthorized person, animal or object into a secured area. The virtual security network system can include sensor units, a drone and a wide area network. Sensor units can be placed throughout a secured area and include a multitude of sensors with different capabilities that can detect a breach of the secured area. The drone can be mobilized upon receipt of a signal from a sensor unit when the secured area is breached to track an intruder. The drone can be equipped with pulsing lasers or a strobe light. The virtual security network system can also include a satellite, unmanned aerial vehicle, a launching and charging station for drone release and/or a drone fleet.

### CROSS-REFERENCE TO RELATED APPLICATIONS

This application is a continuation of International Application No. PCT/US2019/031513 having an international filing date of May 9, 2019 entitled “Autonomous Virtual Wall”. The '513 application is related to and claims priority benefits from U.S. Provisional Application Ser. No. 62/668,846 filed on May 9, 2018, also entitled “Autonomous Virtual Wall”. The '513 and '846 applications are hereby incorporated by reference herein in their entireties.

### FIELD OF THE INVENTION

The present invention relates to a security system, and in particular, to an autonomous security network system that creates a virtual wall to prevent, deter and/or cease intrusion and/or escape by unauthorized personnel, animals and/or objects into and/or out of a secured area.

Existing security measures used to secure the perimeter of a building, complex, jail, campus or geographical area typically include combinations of physical barrier(s), surveillance and/or alarm system(s) and security guard(s) that monitor the surveillance system and/or patrol the area for suspicious activity or trespassers.

Physical barriers such as security walls or fences, even those with barbed wire or anti-climb spikes, can be overcome by determined intruders/prisoners with tools to either scale the structure or breach the structure by cutting, dismantling and/or otherwise breaking down its construction material. Once a security wall or fence is overcome, there often is no additional security measures to deter an intruder/prisoner from entering/leaving a secured and/or private area.

Surveillance and security systems can utilize cameras and motion detectors to provide visual coverage and can be configured to alert security or law enforcement officers if a secured area is breached by an intruder and/or if a prisoner escapes. However, in some instances, the time between an alert being generated and the arrival of responding officers can be enough for an intruder to carry out a prohibited, objectionable or illegal activity and/or for a prisoner to escape.

While manned guarding and patrol services can offer an immediate response and deterrent to intruders/escapees, their effectiveness can be limited by the number and physical health of the security officers. This is of particular importance to expansive and/or difficult-to-patrol areas such as those in remote geographical areas or harsh environmental conditions. In addition, hiring guards is expensive.

The weaknesses of current security measures can be overcome by a security system with the ability to rapidly detect, deter, track and neutralize an intruder/escapee once he or she has breached the perimeter of a secured area. Such a system can have an immediate and multitiered response strategy that can be automatically deployed by the system components which adapt their activity to counter the actions and movement of intruder(s)/escapees.

### SUMMARY OF THE INVENTION

In some embodiments, the system comprises a series of interactive and overlapping security measures to provide an autonomous virtual security network wall system, hereby referred to as a “virtual wall”. This virtual wall can prevent, deter and/or cease intrusion by unauthorized personnel, animals and/or objects into an area secured by the virtual wall components. In some embodiments, the virtual wall can deter and/or cease escape by unauthorized personnel, animals and/or objects from an area secured by the virtual wall components, such as a prison.

A virtual security network system designed to secure an area can include a plurality of sensor units, a drone and/or a wide area network. In some embodiments, the sensor units can detect a breach and transmit a signal to mobilize the drone. In some embodiments, the sensor units are camouflaged.

In some embodiments, the sensor unit includes a microprocessor and transmitter.

In some embodiments, a sensor unit can include, but is not limited to, a combination of a motion detector, a microphone, an infrared camera, an acoustic camera and/or a seismic sensor.

In some embodiments, the virtual security network system can include a satellite with a high-resolution camera and/or an unmanned aerial vehicle.

In some embodiments, the drone can be equipped with audio and/or visual feed, pulsing lasers and/or a strobe light configured to track an intruder.

In some embodiments, the virtual security network system includes a launch station to release and/or charge a drone.

In some embodiments, the virtual security network system also includes a drone fleet.

### BRIEF DESCRIPTION OF THE DRAWINGS

FIG. 1A is a perspective view of a drone.

FIG. 1B is a perspective view of a satellite.

FIG. 1C is a perspective view of an unmanned aerial vehicle.

FIG. 1D is a perspective view of a sensor unit.

FIG. 2 is a perspective view a camouflaged sensor unit providing surveillance of an area secured by a virtual wall.

FIG. 3 is a perspective view of some components of the virtual wall monitoring a secured area.

FIG. 4 is a perspective view of drones reacting to an intruder breaching a boundary of the virtual wall.

FIG. 5 is a perspective view of a drone launching and charging station.

FIG. 6A is a perspective view of an intruder being tracked by a single drone.

FIG. 6B is a perspective view of an intruder being tracked by a drone fleet.

FIG. 7 is a perspective view of a drone with a spotlight deploying an audible warning to an intruder.

FIG. 8 is a perspective view of a buoyant sensor unit and drone launch station.

FIG. 9 is a perspective view of a camouflaged buoyant sensor unit and drone launch station.

FIG. 10 is a perspective view of an autonomous underwater vehicle and an underwater launch station.

FIG. 11 is a flowchart of a multitiered virtual wall system.

### DETAILED DESCRIPTION OF ILLUSTRATIVE EMBODIMENT(S)

A virtual wall can be used to secure a wide range of buildings, complexes, campuses, prisons, homes and/or geographical areas. In some embodiments, a virtual wall is a multitiered response system that automatically deploys various system components and features based on the activity, scent, noise, infrared signature, and/or movement of an unauthorized person, animal and/or object within a secured area.

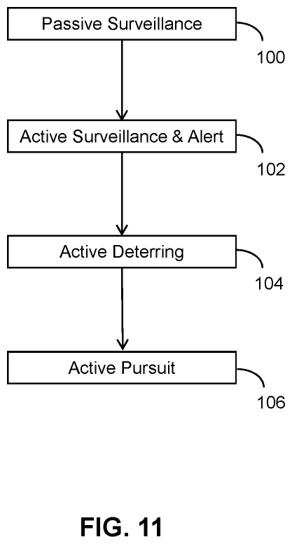

In some embodiments, response system efforts can be divided into response phases, such as but not limited to those shown in the flow chart of FIG. 11. In some embodiments, response phases can be overlapping and/or ongoing phases rather than finite phases with distinct start and end points. In certain embodiments, a user and/or agency can implement the virtual wall in an inconspicuous manner to avoid, or at least reduce, detection of the system until an activating event and/or to not draw attention to the buildings and/or area secured by the virtual wall. In some embodiments, all or at least some of the virtual wall components can be exposed to provide an initial deterrent to potential intruders and/or escapees.

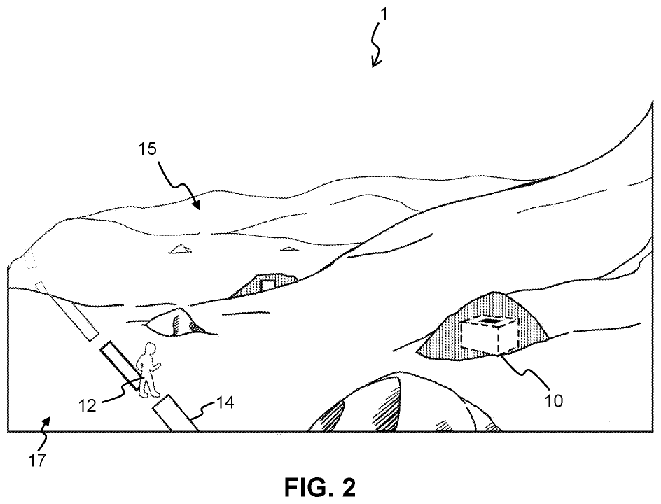

FIG. 2 illustrates a scenario in which an embodiment of a virtual wall system is utilized. In FIG. 2, virtual wall 1 is surveilling and protecting a natural landscape defined by boundary 14 which separates secured area 15 from unsecured area 17.

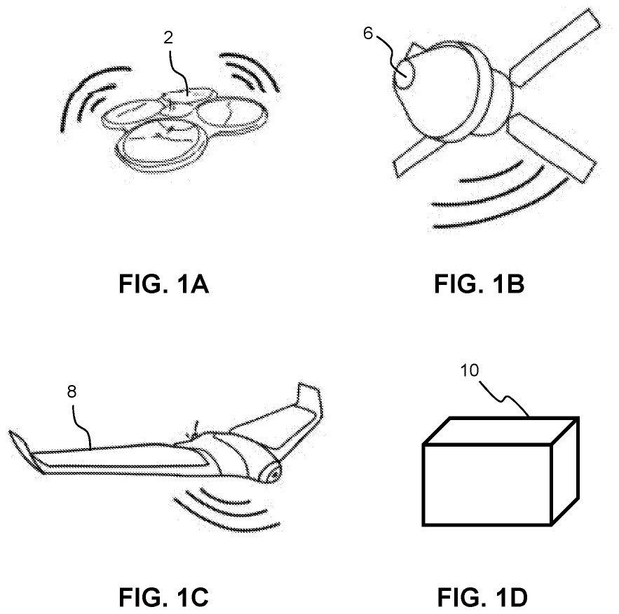

Passive Surveillance Phase 100 of a virtual wall system can include surveillance and monitoring by a closed network of sensors situated along boundary 14 and/or throughout secured area 15. Sensors of virtual wall 1 can include, among other things, directional microphones, cameras, acoustic cameras, infrared cameras, motion detection and capture sensors and/or seismic sensors. In certain embodiments, these sensors can monitor and transmit surveillance-related data to outside services and/or entities. Sensors can be individually placed within a geographical area or grouped together in a sensor unit. An embodiment of a sensor unit 10 is illustrated in FIG. 1D. Sensor unit 10 can be a stand-alone unit placed within a geographical area and/or mounted to building structures within the geographical area. In some embodiments, sensor unit 10 includes a microprocessor and/or a transmitter to receive, integrate and filter analog and digital input from various components of virtual wall 1 and generate output such as potential threats detected within range of sensor unit 10.

In particular embodiments, such as when virtual wall 1 is used in a natural or uninhabited environment such as a field, desert or other outdoor area, sensor unit(s) 10 can be built to blend into its surroundings. For example, sensor unit(s) 10 can be disguised as a rock, shrub, dirt mound and/or other natural element. In some embodiments, sensor unit(s) 10 can be covered with appropriate camouflaging material selected to blend into the structure in which sensor unit(s) 10 is/are placed. For example, in some embodiments, sensor unit(s) 10 can be affixed to a tree and covered in a brown and green camouflaging material. In at least some embodiments, camouflaging or disguising sensor unit(s) 10 is intended to detract or deflect attention away from the area monitored by virtual wall 1. In the scenario illustrated in FIG. 2, sensor unit 10 is disguised as a rock.

Since virtual 1 wall can be used to secure a wide range of geographical areas and various natural landscapes, placement of sensor unit(s) 10 can be customized to accommodate or take advantage of different topographies. For example, in mountainous or irregular terrains, sensor unit(s) 10 can be placed in areas of high elevation to take advantage of larger, panoramic vantage points.

Sensor unit(s) 10 can be a variety of sizes and shapes and made of various materials including, but not limited to, glasses, plastics, steels, metals, metal alloys and/or carbon fiber.

In some embodiments, the placement of sensor unit(s) 10 is/are dependent on the range capabilities of the sensor(s) housed within. In some embodiments, sensors that serve a similar function can have different resolution ranges. For example, sensor unit(s) 10 can have multiple cameras each having a different resolution range. In FIG. 2, the range of sensor unit(s) 10 extends at least to boundary 14. In some embodiments, sensor unit(s) 10 is/are omnidirectional. In some embodiments, sensor unit(s) 10 have a limited range of detection. In some embodiments, the range of at least one sensor unit 10 is universal in multiple directions. In some embodiments, the range at least one sensor unit 10 can be customized for a particular direction. In some embodiments, at least one sensor unit 10 can be configured to rotate and provide 360 degrees of surveillance coverage in the x- and/or y-axis of the sensor. In some embodiments, at least one sensor unit 10 is fixed and provides coverage of a specific area direction.

In some embodiments, virtual wall 1 can detect breaches by large-scale entities including but not limited to motor vehicles, motorcycles, combat vehicles and ATVs. In some embodiments, Doppler radar units and/or Light Imaging Detection And Ranging (LIDAR)-based applications can be incorporated into virtual wall 1 to detect approaching vehicles. In some embodiments, LIDAR-based applications can also be used for vehicle and driver identification. In some embodiments, license plate readers can be used to distinguish authorized and unauthorized vehicles. In some embodiments, security measures can be situated around the perimeter of the area protected by virtual wall 1 and/or at specific entrances and checkpoints in a secured area.

In some embodiments, seismic sensors can be used to detect vehicles, individuals and/or groups of individuals moving near or through a secured area.

In some embodiments, the microprocessor of at least one sensor unit 10 is equipped with facial recognition software and/or audio detection software. In some embodiments, the software can be used by virtual wall 1 to distinguish authorized personnel from unauthorized personnel. For example, if virtual wall 1 is monitoring an undisclosed or otherwise restricted area, the system could distinguish a person allowed to be on the premises from a potential trespasser. This could also assist the system in identifying nonthreatening intrusions such as animals. In some embodiments, at least one sensor unit 10 can include long-range scanners that could be used to read security badges of authorized personnel.

In certain embodiments, virtual wall 1 can include a transmitter that can be affixed to authorized personnel and/or vehicles that allows them access to the secured area without engaging sensor unit(s) 10. In some embodiments the transmitter serves multiple purposes. In some embodiments, it allows authorized personnel to move about the area unrestricted. In addition in some embodiments, by not engaging sensor unit(s) 10, the components of the system remain hidden. In some embodiments, an infrared signal beacon is affixed to authorized personnel and/or vehicles and provides a series of light pulses that can be detected by cameras and indicate to the virtual wall system the person and/or vehicle is not an intruder.

In some embodiments, camera analytics of virtual wall 1 can determine features of a breach event that are considered aggressive and/or hostile based on pre-programmed system parameters that can be configured to engage the system when sensor unit(s) 10 detect a threat. Such parameters can be manually changed or automatically adjusted in response to changing predetermined parameters such as, but not limited to national security advisories, advanced threat knowledge and/or threats anticipated from previous events. In some embodiments, adjustments can be made in connection with artificial intelligence integrated into the virtual wall system.

In certain embodiments, particularly those in which at least one sensor unit is camouflaged and/or disguised as a natural element, sensor unit(s) 10 can also include load cells and/or force sensors to detect physical impact against sensor unit 10. In some embodiments, at least one sensor unit 10 can be configured to recognize and relay different impact signatures such as, but not limited to, those created by a person, animal, vehicle and/or weapon.

In some embodiments, sensor unit(s) 10 can provide passive surveillance of their surroundings to scan for potential breaches of virtual wall 1 by unauthorized persons, animals and/or objects. Passive surveillance can include, but is not limited to, audio, visual, motion and/or force sensing. In some embodiments, sensors can be used to triangulate the position of a breach event. In some embodiments, sensors can be used to determine information such as the type of breach event (person, animal and/or object). In some embodiments, sensors can be used in connection with artificial intelligence to determine audio, visual, motion and/or force sensing signatures.

In embodiments in which force sensors or load cells are included in sensor unit(s) 10, raw impact or force data can be provided to off-site servers, which in turn can identify the source of the force and/or impact by force-vector analysis and/or use of other algorithms.

In some embodiments, at least one sensor unit 10 is configured for bidirectional audio and/or video feed. In some embodiments, audio and/or video feed can be a closed circuit. In some embodiments, audio and/or video feed can be transmitted to outside services and/or entities. In some embodiments, audio and/or video feed can be configured to be passive or active. In some embodiments, at least one sensor unit 10 can be configured to connect to an existing surveillance system used in a building.

Methods of data transmission from at least one sensor unit 10 can include but are not limited to Wi-Fi, secured network or intranet communications, radio frequencies, satellite communications, wired methods and various LTE and 4G/5G networks. Data can be transmitted to devices such as, but not limited to, mobile phones, tablets, laptops, remote servers and/or personal computers.

In some embodiments, the data collected by the components of the virtual wall system is provided to an off-site database server that is part of an encrypted Wide Area Network. The network can also be configured to remotely control, monitor or otherwise communicate with the virtual wall system. In certain embodiments, the communication network of the virtual wall system can include signal jammers to prevent data breaches from unauthorized entities. In some embodiments, signal jammers can be configured to exclude specific communication frequencies.

In some embodiments, the virtual wall system can be connected to a database, such as a national security or criminal database that includes information about known criminals/terrorists. In some embodiments, this database can include physical information about criminals/terrorists such as their pictures. In some embodiments, the virtual wall system can compare information from the database with the information its sensors are collecting to identify the intruder/escape. In some embodiments, the virtual wall system uses facial recognition software.

In some embodiments, at least one sensor unit 10 includes a GPS device to provide location information on data collected through virtual wall 1. In other or the same embodiments, the IP address of microprocessor provides location data.

In some embodiments, the precision and accuracy of virtual wall 1, such as but not limited to the ability to detect, assess and/or distinguish positive from false threats, can be maximized, or at least improved, by placing the system components at distances to minimize, or at least reduce, resolution degradation of the system components.

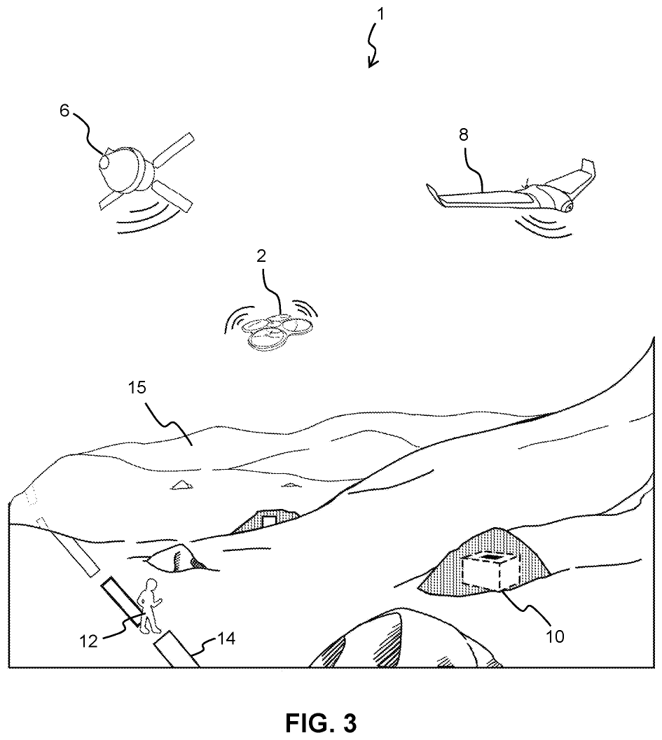

In some embodiments, Passive Surveillance Phase 100 can include use of drone(s) 2, satellite(s) 6 and/or unmanned aerial vehicle(s) 8 shown in FIGS. 1A-1C and 3. Use of these system components can provide aerial and/or generally enhanced ground surveillance of secured area 15. In certain embodiments, Passive Surveillance Phase 100 includes only sensor unit(s) 10. In some embodiments, virtual wall 1 includes only drone(s) 2 set in a patrol mode. In some embodiments, drone(s) 2 can fly. In some embodiments, drone(s) 2 are ground-based.

In some embodiments, virtual wall 1 is configured to allow for 3-dimensional mapping, digital mapping, virtual mapping and/or acoustic mapping of secured area 15 including the terrain and/or on-site security features. In some embodiments, this mapping provides real-time status updates of virtual wall 1 that can be monitored by off-site personnel and/or ground personnel via computers and/or handheld devices. In some embodiments, the mapping can include informational overlays such as, but not limited to, satellite images, topographical information, meteorological information and/or other relevant information such as the political climate or landscape.

In at least some embodiments, during Passive Surveillance Phase 100, sensor unit(s) 10 positioned in a secured area, surveil(s) the landscape for trespassers, intrusions, and/or escapees. In FIG. 2, at least one sensor unit 10 detects trespasser 12 crossing boundary 14 into secured area 15. In at least some embodiments, once trespasser 12 is detected, Active Surveillance and Alert Phase 102 is initiated.

In some embodiments, Active Surveillance and Alert Phase 102 generates notifications to users and/or authorities through various means of wireless and/or digital communication. System information can be transmitted to generate an intruder alert or text message on a mobile phone, transmitted and logged in a mobile phone or tablet-based application unique to virtual wall 1 and/or sent to applications and/or software programs installed on computers of system users and/or law enforcement agencies. In some embodiments, initiation of Active Surveillance and Alert Phase 102, in part, functions to mobilize a proper response team including, but not limited to, law enforcement officers, members of government agencies and/or other security teams.

In some embodiments, system information can be detailed on a virtual map in a user application. The location and movement of the intruding/escaping person, animal and/or object can be tracked based on motion detection analytics, audio feed and/or visual data from sensors and/or drone(s) 2 monitoring the breached region of the secured area. In some embodiments, such data can be used to generate a 3-dimensional topographical terrain map with GPS coordinates to provide real-time updates to response teams on the location and activity of an intruder.

Turning to FIG. 3, Active Surveillance and Alert Phase 102 can include enhanced levels of surveillance by drone(s) 2. In some embodiments, if drone(s) 2 was/were providing long-range ground surveillance during phase 100, it/they can receive a signal transmitted from sensor unit(s) 2 to route them closer to the ground of secured area 15.

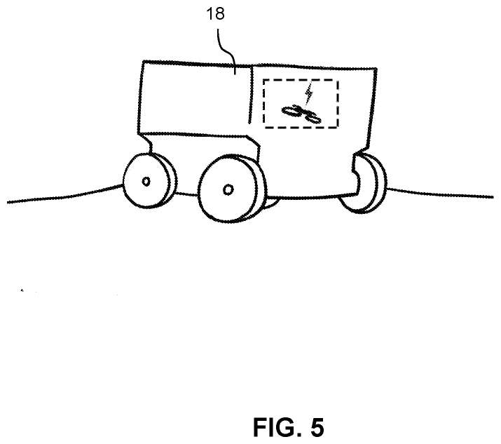

In some embodiments, drone(s) 2 can be released from launch station(s) 18, such as the one shown in FIG. 5. In certain embodiments, launch station(s) 18 can be built into a natural element such as a rock, cove, tree or other appropriate landmass. In at least some embodiments, launch station(s) 18 can be camouflaged to avoid, or at least reduce the chance of, detection. In some embodiments, launch station(s) 18 can be mobile. In some embodiments, drone(s) 2 can be launched manually or automatically in response to a trigger signal generated by sensor unit(s) 10.

In some embodiments, launch station(s) 18 can serve as a drone charging station. Various methods for charging drone(s) 2 can be used including inductive charging, solar charging and/or directly allowing the drone to plug into launch station(s) 18. By allowing drone(s) 2 to charge at launch station(s) 18, drone(s) 2 is/are ready to respond to a security threat and/or breach.

In some embodiments, at least one drone 2 is physically tethered to launch station(s) 18. In other embodiments, at least one drone 2 is released untethered from launch station(s) 18.

In some embodiments, the hovering range of the drone(s) 2 is high enough to prevent, or at least reduce the chance of, disruption of drone(s) 2 function by an intruder/escapee.

In some embodiments, at least one drone 2 can include meteorological sensors, a full-spectrum camera, an infrared camera, speakers and/or circuitry to record, transmit and/or receive audio and video feed. In some embodiments, audio and/or video can be transmittable to outside services and/or entities. In some embodiments, audio and/or video feed of drone(s) 2 can be configured to be passive or active.

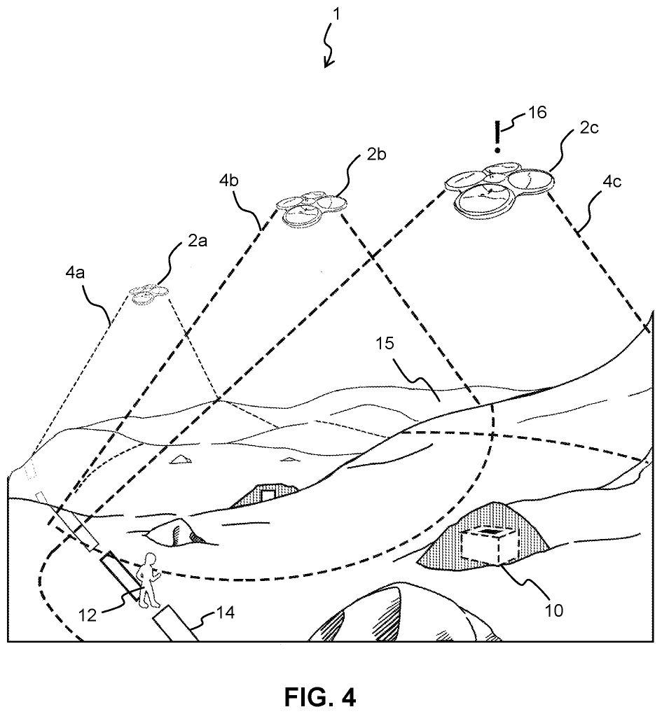

FIG. 4 shows multiple drones 2a-2c responding to alert signal 16 received from at least one sensor unit 10. In some embodiments, at least one drone 2 is configured to establish surveillance of a predefined region of a response site. For example, in some embodiments, drones 2a, 2b and 2c can be arranged equidistant from one another and provide overlapping surveillance regions 4a-4c around intruder 12. In certain embodiments, use of camera(s) in drones 2a, 2b and 2c can be used to create a bi-optic or multi-optic mapping overlay for a 3-dimensional, digital and/or virtual map of secured area 15. In some or the same embodiments, such mapping overlays can also be provided to displays in augmented reality headgear worn by security agents, response teams and other personnel.

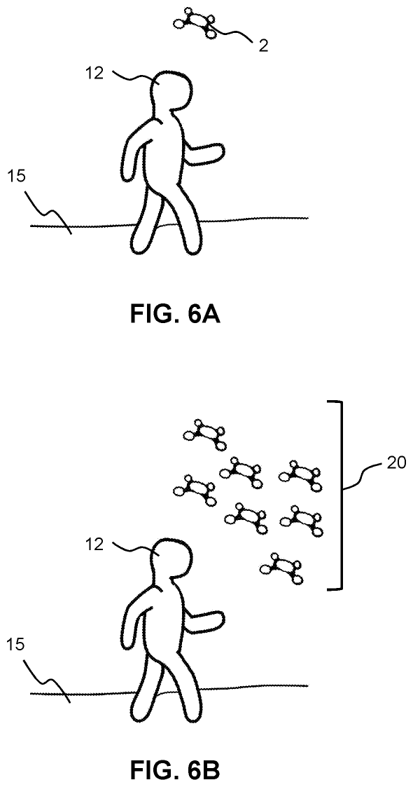

In some embodiments, drone(s) 2 is/are released singularly as shown in FIG. 6A. In other embodiments, drones 2 are released in fleets as shown in FIG. 6B.

The virtual wall system 1 can utilize drone(s) 2 and other optional system components in overlapping Active Deterring Phase 104 and Active Pursuit Phase 106 which function to drive an intruder out of a secured area. Active Deterring Phase 104 and Active Pursuit Phase 106 can include various physical and/or psychological tactics designed to intimidate and disarm the intruder in such a way that he or she elects to remove himself or herself from a secured area.

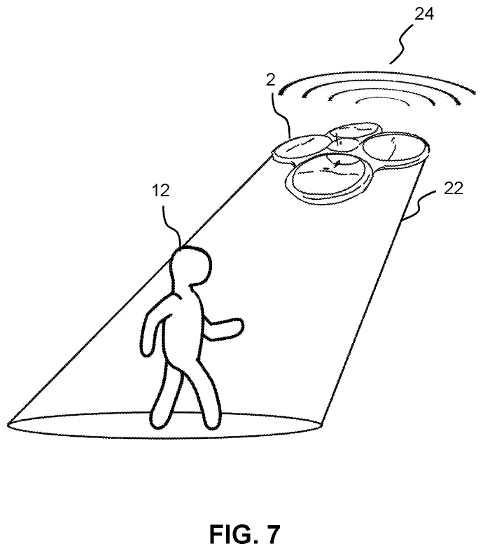

In some embodiments, drone(s) 2 are equipped with means of deterring an intruder such as pulsing lasers, strobe lights, bright lights and/or abrasive or obnoxious sounds played at high volume and/or damaging decibel levels. In certain embodiments, the speakers of drone(s) 2 can play pre-recorded commands such as “unauthorized person on premises”, “remove yourself from this area”, “law enforcement agents are on their way” or “you have 90 seconds to remove yourself from this area”. In some embodiments, recorded commands can be multilingual. In some embodiments, a system user can use speaker(s) of drone(s) 2 to issue real-time warnings. These deterring measures can be repeated in regularly-timed intervals or run continuously. FIG. 7 shows drone 2 following intruder 12 with spotlight 22 while playing acoustics 24.

In certain embodiments, drone(s) 2 can also play pre-recorded animal sounds. In some embodiments, this can assist in expelling an unwanted animal from secured area 15.

In some embodiments, virtual wall 1 can activate a high-pressured watering system situated in the secured area in response to signals received from at least one sensor unit 10 during a breach. Intruder location data can be provided to the watering system to direct a water stream at the intruder. In some embodiments, the watering system can create a high-pressured wall of water to prevent further access into/out of the secured area.

In some embodiments, if an intruder does not elect to remove himself or herself from a secured area within a predetermined amount of time, virtual wall 1 can advance to Active Pursuit Phase 106.

In some embodiments, during Active Pursuit Phase 106, drone(s) 2 or drone fleet(s) 20, shown in FIGS. 6A and 6B, can be configured to stalk, chase, tail or swarm intruder 12 to drive intruder 12 out of secured area 15. In some embodiments, drone(s) 2 are equipped with extendable panels that increase the surface area of drone(s) 2 so as to create a larger or more formidable barrier to prevent, or at least reduce the chance of, an intruder from advancing into a secured area.

In some embodiments, drone fleet 20 is configured to coordinate various drone arrangements to create a dynamic, mobile barrier to prevent or at least reduce the chance of, an intruder from advancing into a secured area. In some embodiments, this configuration can also be used to “push” an intruder out of a secured area by advancing on the intruder. Such configurations can include sharp, randomly-timed lateral movements toward the intruder by individual drone(s) 2 of the fleet to startle or disorient the intruder.

In at least some embodiments, waves of swarm and/or nano drone fleets can be deployed to chase an intruder out of a secured area and/or create a mobile barrier to prevent or deter an intruder from advancing into a secured area. Such drone waves could be deployed at regular intervals. When an individual drone 2 requires charging, it can be configured to automatically remove itself from the fleet and relocate to a charging station. Replacement drone(s) 2 can take over the position vacated by the depleted drone(s) 2. This prevents, or at least reduces the chance of depleted drone(s) 2 from becoming a tactile weakness in the drone fleet.

Active Pursuit Phase 106 can include the use of ground-based and air-based autonomous vehicles to chase an intruder out of a secured area and provide additional infrared, visible or full-spectrum light beacons and spotlights to illuminate and/or disorient a target. In some embodiments, ground-based autonomous vehicles can serve as drone charging stations.

In the case of multiple intruders, air and ground-based drones and vehicles can be configured to divide, track and deter multiple targets at once.

In some embodiments of virtual wall 1 or in some embodiments of the virtual wall phases, at least one satellite 6 and at least one unmanned aerial vehicle 8 can be used as shown in FIG. 3. Satellite(s) 6 and unmanned aerial vehicle(s) 8 can perform covert reconnaissance and enhanced surveillance in secured areas and provide communications to a Wide Area Network. Such communications can include data on unauthorized ground or aerial traffic. In at least some embodiments, unmanned aerial vehicle(s) 8 are fixed-wing and circle at high altitudes to reduce the operational noise of the unmanned aerial vehicle(s) 8 to avoid detection. In some preferred embodiments, unmanned aerial vehicle(s) 8 operate in the range between 10,000 and 40,000 feet. Flight altitudes can be altered depending on meteorological conditions, visibility and other flight and/or mission details. In some embodiments, unmanned aerial vehicle(s) 8 can include solar panels for charging that allow for extended flights. Satellite(s) 6 can further provide for secured and encrypted communications.

In some embodiments, at least one satellite 6 is equipped with a high-resolution camera capable of enhanced surveillance of areas secured by virtual wall 1 that can be hotspots for potential intruders and other threats.

In at least some embodiments, unmanned aerial vehicle(s) 8, satellite(s) 6, drone(s) 2 and/or sensor(s) 10 of the virtual wall system are configured to allow bidirectional communication of system components.

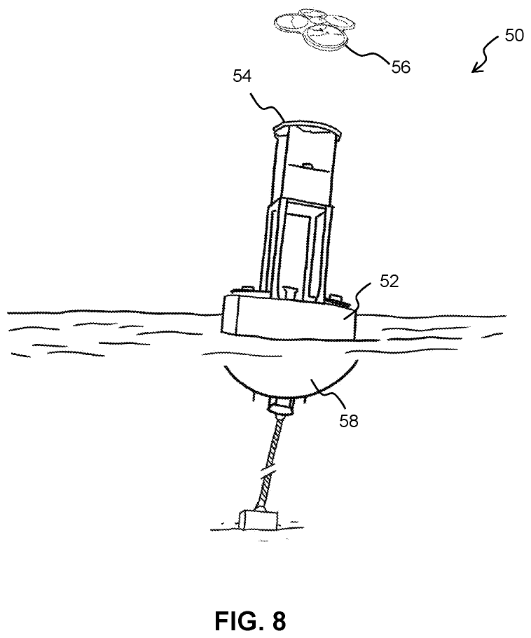

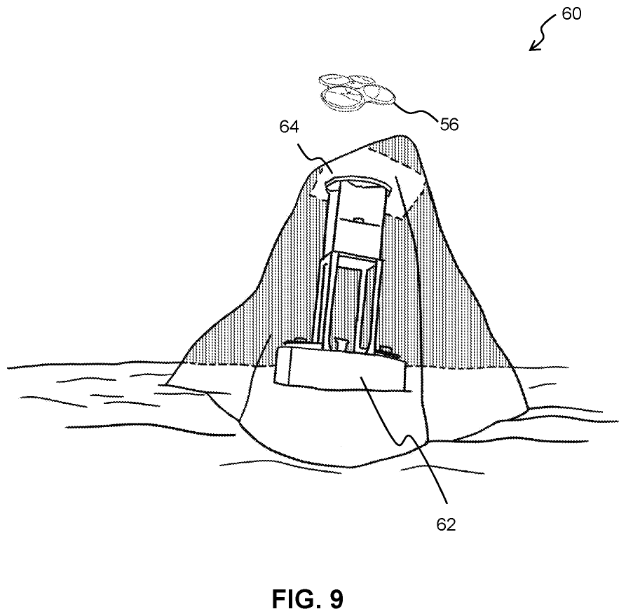

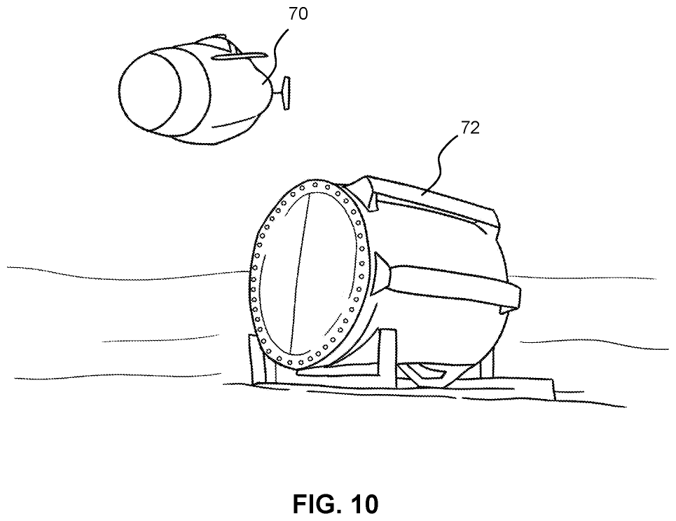

Turning to FIG. 8, another embodiment of a virtual wall is shown which can be used in areas with bodies of water. Sensor unit 52 of virtual wall 50 can be configured to float by attachment to buoy 58 and placed in a body of water. In some embodiments, drone launch station 54 can be fastened on top of sensor unit 52 to charge and release drone(s) 56 in response to maritime security threats. In some embodiments, such as the one shown in FIG. 9, sensor unit 62 and drone launch station 64 are camouflaged. In a particular embodiment of virtual wall 60, sensor unit 62 and drone launch station 64 are camouflaged to look like a rock formation.

Sensor units 52, launch station 54, sensor units 62, and/or launch station 56, can be anchored to the seafloor or free-floating. Such embodiments can be used in salt water and/or fresh water to guard smuggling or pirate routes, prisons, ports and/or provide general surveillance of a coastline.

In some embodiments, virtual wall 50 and/or virtual wall 60 can also include at least one underwater launch station 72, In at least some embodiments, at least one underwater launch station 72 releases underwater autonomous vehicle(s) 70 in response to threats detected by sensor unit(s). Underwater autonomous vehicle(s) 70 can be used to covertly track unauthorized intrusions or suspicious vessels in a body of water. Underwater autonomous vehicle 70(s) can work independently and/or in conjunction with drone(s) 2, satellite(s) 6, coastline sensor unit(s) 10 and/or unmanned aerial vehicle(s) 8 to provide underwater and aerial coverage of potential threats.

In some embodiments, a series of floating buoy beacons can be incorporated into the system to track tides and ocean currents. Such information can be transmitted to drone(s) 2 and/or underwater autonomous vehicle(s) 8 to determine optimal travel paths.

In particular embodiments, virtual wall 1 can be used to secure airports and monitor restricted airspace and employ similar methods to remove unauthorized drones from such places.

In certain embodiments, the virtual wall system can be configured to monitor animal sanctuaries and track endangered animals to prevent, or at least reduce the chance of, poaching.

In certain embodiments, the virtual wall system can be used in concert with existing wildfire protection infrastructure. In some embodiments, high-altitude autonomous drones 2 equipped with visual/thermal sensing and/or imaging capabilities can scan areas susceptible to wildfires such as heavily wooded or dry landscapes to find sources of wildfires and relay information to fire protection services. In certain embodiments, this information can be used to determine aerial routes and safe landing zones for firefighters and first responders. In some embodiments, drone(s) 2 can be equipped with fire retardant chemical systems loaded into the drone at a base station and/or from an onboard tank. In some embodiments, the drones 2 could act as a first line of defense against encroaching fires and deploy in response to signals transmitted from meteorological, thermal, chemical and other trace sensors. Such sensors can reside in wildfire-vulnerable areas or circulated via drones to wildfire-vulnerable areas when environmental conditions are optimal for wildfires.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A virtual security network system to secure an area comprising:
a) a plurality of sensor units, wherein at least a first sensor unit of said plurality of sensor units is capable of detecting a breach of a perimeter of said area and transmitting information related to said breach;
b) a first drone, wherein said first drone is mobilized in response to a signal transmitted from said plurality of sensor units; and
c) a wide area network, wherein said wide area is configured for bidirectional communication with said drone and said sensor units.

2. The virtual security network system of claim 1, wherein said first sensor unit includes a microprocessor and a transmitter.

3. The virtual security network system of claim 1, wherein said first sensor unit includes an at least one motion detector.

4. The virtual security network system of claim 1, wherein said first sensor unit includes a microphone.

5. The virtual security network system of claim 1, wherein said first sensor unit includes a camera.

6. The virtual security network system of claim 5, wherein said camera is one of an infrared camera or an acoustic camera

7. The virtual security network system of claim 1, wherein said first sensor unit includes a seismic sensor.

8. The virtual security network system of claim 1, wherein said first sensor unit is camouflaged to blend into said area.

9. The virtual security network system of claim 1, wherein said signal is transmitted to said first drone in response to said breach.

10. The virtual security network system of claim 1, further comprising:
d) a satellite, wherein said satellite is equipped with a high-resolution camera.

11. The virtual security network system of claim 1, further comprising:
d) an unmanned aerial vehicle.

12. The virtual security network system of claim 1, wherein said first drone is equipped with audio and visual feed.

13. The virtual security network system of claim 1, wherein said first drone is configured to track an intruder.

14. The virtual security network system of claim 1, wherein said first drone is equipped with a plurality of pulsing lasers.

15. The virtual security network system of claim 1, wherein said first drone is equipped with a strobe light.

16. The virtual security network system of claim 1, further comprising:
d) a launch station, wherein said launch station releases said first drone.

17. The virtual security network system of claim 16, wherein said launch station can charge said first drone.

18. The virtual security network system of claim 1, further comprising:
d) a drone fleet, wherein said drone fleet comprises at least three drones.

19. The virtual security network system of claim 1, further comprising:
d) a security badge configured to identify an authorized personnel.

20. The virtual security network system of claim 1, further comprising:
d) an infrared signal beacon configured to identify an authorized personnel.
